(19) United States
(12) Patent Application Publication
(10) Pub. No.: US 2024/0106171 A1
(43) Pub. Date: Mar. 28, 2024

(54) MALE CONNECTOR, FEMALE CONNECTOR AND ELECTRICAL CONNECTOR ASSEMBLY

(71) Applicant: LOTES CO., LTD, Keelung (TW)

(72) Inventors: Po Jui Chou, Keelung (TW); Zhi Guo Peng, Keelung (TW); Chien Chih Ho, Keelung (TW); Hui Yi, Keelung (TW)

(21) Appl. No.: 18/367,512

(22) Filed: Sep. 13, 2023

(30) Foreign Application Priority Data
Sep. 23, 2022 (CN) 202211163008.0

(51) Int. Cl. H01R 13/6583; H01R 13/424; H01R 13/6586

(52) U.S. Cl. CPC H01R 13/6583; H01R 13/424; H01R 13/6586

(57) ABSTRACT

An electrical connector assembly includes: a male connector, provided with a conductive shell; a first substrate, accommodated in the conductive shell and used to transmit receiving signals; a second substrate, accommodated in the conductive shell and used to transmit sending signals; a shielding sheet, located between the first substrate and the second substrate; a female connector, provided with a first conductive body and a second conductive body; a plurality of first signal terminals, accommodated in the first conductive body and used to transmit receiving signals; and a plurality of second signal terminals, accommodated in the second conductive body and used to transmit sending signals. The first signal terminals and the first substrate are electrically contacted to each other. The second signal terminals and the second substrate are electrically contacted to each other. The first conductive body and/or the second conductive body are used to lap joint with the shielding sheet.

### CROSS-REFERENCE TO RELATED PATENT APPLICATION

This non-provisional application claims priority to and the benefit of, pursuant to 35 U.S.C. § 119(a), patent application Serial No. CN202211163008.0 filed in China on Sep. 23, 2022. The disclosure of the above application is incorporated herein in its entirety by reference.

Some references, which may include patents, patent applications and various publications, are cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference were individually incorporated by reference.

### FIELD

The present invention relates to a male connector, a female connector and an electrical connector assembly, and particularly to an electrical connector assembly electrically contacting a first mating component and a second mating component.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Two adjacent transmission signal lines includes: a first transmission signal line having a first output end sending signals and a first input end receiving the sending signals from the first output end, and a second transmission signal line having a second output end sending signals and a second input end receiving the sending signals from the second output end. When the first input end and the second output end are located at a same side and the first output end and the second input end are located at another same side, the first input end receives the signal interference sent from the second output end, and the second input end receives the signal interference sent from the first output end, which are the near-end crosstalk (NEXT). In the related art, there is an electrical connector assembly, including a male connector and a female connector. The male connector includes a conductive shell, and a first substrate and a second substrate accommodated in the conductive shell. The first substrate is provided with a plurality of first signal pads used to transmit receiving signals and a plurality of second signal pads used to transmit sending signals arranged in a row, and the second substrate is provided with a plurality of first signal pads used to transmit receiving signals and a plurality of second signal pads used to transmit sending signals arranged in a row. The female connector includes a first insulating body and a second insulating body. The first insulating body is provided with a first insertion slot, and a plurality of first signal terminals and a plurality of second signal terminals are accommodated in the first insulating body and protrude out of the first insertion slot. The second insulating body is provided with a second insertion slot, and a plurality of first signal terminals and a plurality of second signal terminals are accommodated in the second insulating body and protrude out of the second insertion slot. When the male connector is inserted into the female connector, the first substrate is inserted into the first insertion slot, the first signal pads and the first signal terminals are in electrical contact with each other, the second substrate is inserted into the second insertion slot, and the second signal pads and the second signal terminals are in electrical contact with each other.

The structure as described above has the following deficiencies:
1. The first substrate is provided with a plurality of first signal pads used to transmit receiving signals and a plurality of second signal pads used to transmit sending signals. The first signal pads receive the signal interference sent from the second signal pads, and the NEXT exists between the first signal pads and the second signal pads of the first substrate. The second substrate is provided with a plurality of first signal pads used to transmit receiving signals and a plurality of second signal pads used to transmit sending signals. The first signal pads receive the signal interference sent from the second signal pads, and the NEXT exists between the first signal pads and the second signal pads of the second substrate.
2. The first signal pads of the first substrate receive the signal interference sent from the second signal pads of the second substrate, and crosstalk exists between the first signal pads of the first substrate and the second signal pads of the second substrate. The first signal pads of the second substrate receive the signal interference sent from the second signal pads of the first substrate, and crosstalk exists between the first signal pads of the second substrate and the second signal pads of the first substrate.
3. The first signal terminals located at the first insulating body receive the signal interference sent from the second signal terminals located at the first insulating body, and crosstalk exists between the first signal terminals located at the first insulating body and the second signal terminals located at the first insulating body. The first signal terminals located at the second insulating body receive the signal interference sent from the second signal terminals located at the second insulating body, and crosstalk exists between the first signal terminals located at the second insulating body and the second signal terminals located at the second insulating body.
4. The first signal terminals located at the first insulating body receive the signal interference sent from the second signal terminals located at the second insulating body, and crosstalk exists between the first signal terminals located at the first insulating body and the second signal terminals located at the second insulating body. The first signal terminals located at the second insulating body receive the signal interference sent from the second signal terminals located at the first insulating body, and crosstalk exists between the first signal terminals located at the second insulating body and the second signal terminals located at the first insulating body.

Therefore, a heretofore unaddressed need to design a new electrical connector assembly exists in the art to address the aforementioned deficiencies and inadequacies.

### SUMMARY

In view of the deficiencies in the background technology, the present invention is directed to an electrical connector assembly, in which a first substrate of a male connector is provided with a plurality of first signal pads used to only transmit receiving signals, such that a near-end crosstalk in the first substrate is minimized; a second substrate of the male connector is provided with a plurality of second signal pads used to only transmit sending signals, such that a near-end crosstalk in the second substrate is minimized; a shielding sheet is provided between the first substrate and the second substrate to lap joint with a first conductive body and/or a second conductive body of a female connector, such that the crosstalk between the first substrate and the second substrate and between the first signal terminals and the second signal terminals are minimized.

To achieve the foregoing objective, the present invention adopts the following technical solutions.

A male connector includes: a conductive shell; a first substrate, accommodated in the conductive shell, wherein the first substrate has a plurality of first signal pads arranged in a row, and the first signal pads are configured to transmit receiving signals; a second substrate, accommodated in the conductive shell, wherein the second substrate has a plurality of second signal pads arranged in a row, and the second signal pads are configured to transmit sending signals; and a shielding sheet, accommodated in the conductive shell and located between the first substrate and the second substrate.

In certain embodiments, the first substrate has a first outer edge, each of the first signal pads has a first inner edge, the shielding sheet has a second outer edge, and viewing a front-rear direction, the second outer edge is located between the first inner edge and the first outer edge, or the second outer edge and the first outer edge are flush.

In certain embodiments, the conductive shell is concavely provided with a mating slot along a front-rear direction, the mating slot is provided with a mating opening, the shielding sheet is provided with a plurality of sets of elastic sheets, each of the sets of elastic sheets has a first elastic sheet and a second elastic sheet, a free end of the first elastic sheet and a free end of the second elastic sheet both extend toward a side away from the mating opening, and viewing along a vertical direction, an extending direction of the free end of the first elastic sheet and an extending direction of the free end of the second elastic sheet are opposite to each other.

In certain embodiments, the conductive shell is concavely provided with a mating slot along a front-rear direction, the shielding sheet is provided with a plurality of through slots and at least one elastic sheet located in the through slots, each of the through slots is provided with a second inner edge, the mating slot is provided with a third inner edge, each of the first substrate and the second substrate has a first outer edge, and the second inner edge is located between the first outer edge and the third inner edge.

A female connector includes: a first conductive body, provided with a first insertion slot; a second conductive body, provided with a second insertion slot; an accommodating slot, located between the first conductive body and the second conductive body and configured to accommodate a shielding sheet of a male connector, wherein the first conductive body and the second conductive body are configured to be contacted to the shielding sheet; a plurality of first signal terminals, accommodated in the first conductive body and protruding out of the first insertion slot, wherein the first signal terminals are configured to transmit receiving signals; and a plurality of second signal terminals, accommodated in the second conductive body and protruding out of the second insertion slot, wherein the second signal terminals are configured to transmit sending signals.

In certain embodiments, the first conductive body is provided with a plurality of receiving slots at least arranged in a row along a left-right direction, each of the receiving slots is provided with a first conductive wall and a second conductive wall at two opposite sides and two third conductive walls connecting the first conductive wall and the second conductive wall, a portion of the first conductive wall and a portion of the second conductive wall are located at two opposite sides of a corresponding one of the first signal terminals along a vertical direction, the second conductive wall is provided with an opening at a location adjacent to the first insertion slot, each of the receiving slots is in communication with the first insertion slot through the opening, two adjacent ones of the receiving slots are separated by one of the third conductive walls, each of the receiving slots accommodates at least one of the first signal terminals, each of the first signal terminals has a contact portion, a fixing portion and an elastic portion connecting the contact portion and the fixing portion, the fixing portion and the elastic portion of the corresponding one of the first signal terminals are shielded by the second conductive wall, and the contact portion protrudes out of the first insertion slot through the opening.

In certain embodiments, the first conductive body is provided with a plurality of receiving slots at least arranged in a row along a left-right direction, each of the receiving slots accommodates at least one of the first signal terminals, each of the receiving slots is provided with a first conductive wall, a second conductive wall and a fourth conductive wall connecting the first conductive wall and the second conductive wall, a portion of the first conductive wall and a portion of the second conductive wall are located at two opposite sides of a corresponding one of the first signal terminals along a vertical direction, and the fourth conductive wall is located in front of the corresponding one of the first signal terminals.

In certain embodiments, the first conductive body is provided with a plurality of receiving slots at least arranged in a row along a left-right direction, each of the receiving slots accommodates a plastic block and at least one of the first signal terminals, each of the receiving slots is provided with a first conductive wall and a second conductive wall at two opposite sides, a portion of the first conductive wall and a portion of the second conductive wall are located at two opposite sides of a corresponding one of the first signal terminals along a vertical direction, the second conductive wall is provided with an opening at a location adjacent to the first insertion slot, each of the receiving slots is in communication with the first insertion slot through the opening, each of the first signal terminals has a contact portion protruding out of the first insertion slot through the opening, the plastic block has a first portion located between the contact portion and the first conductive wall, the first portion and the contact portion are provided at an interval, the second conductive wall has a wall surface located in a corresponding one of the receiving slots, and the first portion protrudes toward the opening and does not pass beyond the wall surface.

In certain embodiments, the first conductive body is provided with a plurality of receiving slots at least arranged in a row along a left-right direction, each of the receiving slots accommodates an insulating block, a plastic block and at least one of the first signal terminals, each of the first signal terminals has a contact portion, an elastic portion connected to the contact portion and a fixing portion connected to the elastic portion arranged forward from a front thereof, the fixing portion and the insulating block are formed by insert-molding, each of the receiving slots is provided with a fourth conductive wall located in front of the contact portion, and the plastic block is located between the fourth conductive wall and the insulating block.

In certain embodiments, each of the receiving slots is provided with a first conductive wall and a second conductive wall, a portion of the first conductive wall and a portion of the second conductive wall are located at two opposite sides of a corresponding one of the first signal terminals along a vertical direction, the plastic block has a first abutting surface and a second abutting surface opposite to each other vertically, the first abutting surface abuts against the first conductive wall, and/or the second abutting surface abuts against the second conductive wall.

In certain embodiments, the first conductive body is provided with a plurality of receiving slots at least arranged in a row along a left-right direction, each of the receiving slots is provided with a first conductive wall located at one side of a corresponding one of the first signal terminals, each of the first signal terminals has a fixing portion and a conductive portion connected to the fixing portion, a connecting member is electrically contacted to the conductive portion, the connecting member is located at one side of the conductive portion adjacent to the first conductive wall, the first conductive wall is provided with a plate portion located at one side of the fixing portion and a protruding portion bending and extending from the plate portion toward a direction away from one end of the conductive portion, and a distance between the protruding portion and the conductive portion is greater than a distance between the plate portion and the fixing portion.

In certain embodiments, the female connector further includes an insulating shell, covering the first conductive body and the second conductive body, wherein the insulating shell, the first conductive body and a first conductive plastic altogether surround to form the first insertion slot, the insulating shell, the second conductive body and a second conductive plastic altogether surround to form the second insertion slot, the insulating shell, the first conductive body, the second conductive body and a third conductive plastic altogether surround to form the accommodating slot, each of the first conductive body and the second conductive body is provided with a plurality of receiving slots arranged in two rows along a left-right direction, the receiving slots have a plurality of first receiving slots and a plurality of second receiving slots, each of the first receiving slots of the first conductive body accommodates at least one of the first signal terminals, each of the second receiving slots of the first conductive body accommodates a first ground terminal, the first ground terminal and the first conductive body are in direct contact, each of the first receiving slots of the second conductive body accommodates at least one of the second signal terminals, each of the second receiving slots of the second conductive body accommodates a second ground terminal, the second ground terminal and the second conductive body are in direct contact, the first signal terminals and the second signal terminals are provided horizontally, and the first ground terminal and the second ground terminal are provided vertically.

An electrical connector assembly includes: a male connector, provided with a conductive shell; a first substrate, accommodated in the conductive shell, wherein the first substrate is configured to transmit receiving signals; a second substrate, accommodated in the conductive shell, wherein the second substrate is configured to transmit sending signals; at least one shielding sheet, accommodated in the conductive shell and located between the first substrate and the second substrate; a female connector, provided with a first conductive body, a second conductive body and an accommodating slot located between the first conductive body and the second conductive body, wherein the first conductive body is provided with a first insertion slot, and the second conductive body is provided with a second insertion slot; a plurality of first signal terminals, accommodated in the first conductive body and protruding out of the first insertion slot, wherein the first signal terminals are configured to transmit the receiving signals; and a plurality of second signal terminals, accommodated in the second conductive body and protruding out of the second insertion slot, wherein the second signal terminals are configured to transmit the sending signals. When the male connector and the female connector mate with each other, the first insertion slot is configured to accommodate the first substrate, the first signal terminals and the first substrate are electrically contacted to each other, the second insertion slot is configured to accommodate the second substrate, the second signal terminals and the second substrate are electrically contacted to each other, the accommodating slot is configured to accommodate the shielding sheet, and the first conductive body and/or the second conductive body are configured to lap joint with the shielding sheet.

In certain embodiments, the conductive shell is concavely provided with a mating slot along a front-rear direction, the mating slot is provided with a mating opening, the shielding sheet is provided with a plurality of sets of elastic sheets, each of the sets of elastic sheets has a first elastic sheet and a second elastic sheet, the first elastic sheet is configured to lap joint with the first conductive body, the second elastic sheet is configured to lap joint with the second conductive body, a free end of the first elastic sheet and a free end of the second elastic sheet both extend toward a side away from the mating opening, and viewing along a vertical direction, an extending direction of the free end of the first elastic sheet and an extending direction of the free end of the second elastic sheet are opposite to each other.

In certain embodiments, the conductive shell is concavely provided with a mating slot along a front-rear direction, the shielding sheet is provided with a plurality of through slots and at least one elastic sheet located in the through slots, the elastic sheet is configured to lap joint with the first conductive body and/or the second conductive body, each of the through slots is provided with a second inner edge, the mating slot is provided with a third inner edge, each of the first substrate and the second substrate has a first outer edge, the second inner edge is located between the first outer edge and the third inner edge, and when the male connector and the female connector mate with each other, the first conductive body and the second conductive body are accommodated in the mating slot and are respectively located at two opposite sides of the through slot in a vertical direction.

In certain embodiments, the first conductive body is provided with a plurality of receiving slots at least arranged in a row along a left-right direction, each of the receiving slots accommodates a plastic block and at least one of the first signal terminals, each of the receiving slots is provided with a first conductive wall and a second conductive wall at two opposite sides, a portion of the first conductive wall and a portion of the second conductive wall are located at two opposite sides of a corresponding one of the first signal terminals along a vertical direction, the second conductive wall is provided with an opening at a location adjacent to the first insertion slot, each of the receiving slots is in communication with the first insertion slot through the opening, each of the first signal terminals has a contact portion protruding out of the first insertion slot through the opening and an elastic portion connected to the contact portion, the plastic block has a first portion located between the contact portion and the first conductive wall and a second portion located between the elastic portion and the first conductive wall, and when the male connector and the female connector mate with each other, the first substrate and the contact portion abut against each other, the contact portion and the first portion are provided at an interval, and the elastic portion and the second portion are in contact with each other.

In certain embodiments, the shielding sheet is provided with a plurality of sets of elastic sheets, each of the sets of elastic sheets has a first elastic sheet and a second elastic sheet, the first elastic sheet is configured to upward lap joint with the first conductive body, the second elastic sheet is configured to downward lap joint with the second conductive body, each of the first signal terminals has a contact portion in electrical contact with the first substrate, each of the second signal terminals has a contact portion in electrical contact with the second substrate, and viewing along a vertical direction, the first elastic sheet and the second elastic sheet overlap with a projection of the contact portion.

Compared to the related art, certain embodiments of the present invention have the following beneficial effects:
1. The first substrate of the male connector is provided with a plurality of first signal pads only used to transmit receiving signals, such that the NEXT in the first substrate is minimized. The second substrate of the male connector is provided with a plurality of second signal pads only used to transmit sending signals, such that the NEXT in the second substrate is minimized.
2. The first signal pads of the first substrate receive the electromagnetic signal interference sent from the second signal pads of the second substrate, but the male connector is provided with a shielding sheet between the first substrate and the second substrate, which may isolate most of the electromagnetic signal interference between the first substrate and the second substrate.
3. The female connector is provided with a plurality of first signal terminals arranged in a row and used only to transmit the receiving signals and a plurality of second signal terminals arranged in a row and used only to transmit the sending signals, such that the NEXT among the first signal terminals is minimized and the NEXT among the second signal terminals is minimized.
4. The first signal terminals receive the signal interference sent from the second signal terminals, but the female connector is provided with a first conductive body covering the first signal terminals and a second conductive body covering the second signal terminals, and the first conductive body and the second conductive body may isolate most of the electromagnetic signal interference between the first signal terminals and the second signal terminals.
5. When the male connector is inserted into the female connector, under the condition that the shielding sheet lap joints with the first conductive body and/or the second conductive body, the shielding sheet may shield the electromagnetic signal interference between the first signal terminals and the second signal terminals at a location of the opening of the female connector, and the first conductive body and/or the second conductive body may shield the electromagnetic signal interference between the first signal pads and the second signal pads at a location of the opening of the male connector.
6. The shielding sheet simultaneously lap joints with the first conductive body and the second conductive body, thus facilitating the common grounding of the first conductive body and the second conductive body at the lap joint location, ensuring an equal electrical potential, which is conducive to enhancing the shielding effect, and further reducing the electromagnetic signal interference.

These and other aspects of the present invention will become apparent from the following description of the preferred embodiment taken in conjunction with the following drawings, although variations and modifications therein may be effected without departing from the spirit and scope of the novel concepts of the disclosure.

### BRIEF DESCRIPTION OF THE DRAWINGS

The accompanying drawings illustrate one or more embodiments of the disclosure and together with the written description, serve to explain the principles of the disclosure. Wherever possible, the same reference numbers are used throughout the drawings to refer to the same or like elements of an embodiment, and wherein:

FIG. 1 is a perspective view of a male connector and a female connector according to certain embodiments of the present invention.

FIG. 2 is a sectional view of the male connector and the female connector mating with each other according to certain embodiments of the present invention.

FIG. 3 is an enlarged view of a location A in FIG. 2 according to certain embodiments of the present invention.

FIG. 4 is a perspective sectional view of the male connector according to certain embodiments of the present invention.

FIG. 5 is an enlarged view of a location B in FIG. 4 according to certain embodiments of the present invention.

FIG. 6 is a sectional view of signal terminals of the female connector according to certain embodiments of the present invention.

FIG. 7 is a sectional view of ground terminals of the female connector according to certain embodiments of the present invention.

FIG. 8 is a partial disassembled view of the female connector according to certain embodiments of the present invention.

FIG. 9 is a simulation test chart showing comparison of the near-end crosstalk (NEXT) between a pair of signal terminals of the electrical connector assembly of the related art and a pair of signal terminals of the electrical connector assembly according to certain embodiments of the present invention.

FIG. 10 is a simulation test chart showing comparison of the far-end crosstalk (FEXT) between a pair of signal terminals of the electrical connector assembly of the related art and a pair of signal terminals of the electrical connector assembly according to certain embodiments of the present invention.

### DETAILED DESCRIPTION

The present invention is more particularly described in the following examples that are intended as illustrative only since numerous modifications and variations therein will be apparent to those skilled in the art. Various embodiments of the invention are now described in detail. Referring to the drawings, like numbers indicate like components throughout the views. As used in the description herein and throughout the claims that follow, the meaning of “a”, “an”, and “the” includes plural reference unless the context clearly dictates otherwise. Also, as used in the description herein and throughout the claims that follow, the meaning of “in” includes “in” and “on” unless the context clearly dictates otherwise. Moreover, titles or subtitles may be used in the specification for the convenience of a reader, which shall have no influence on the scope of the present invention.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower”, can therefore, encompasses both an orientation of “lower” and “upper,” depending of the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

As used herein, “around”, “about” or “approximately” shall generally mean within 20 percent, preferably within 10 percent, and more preferably within 5 percent of a given value or range. Numerical quantities given herein are approximate, meaning that the term “around”, “about” or “approximately” can be inferred if not expressly stated.

As used herein, the terms “comprising”, “including”, “carrying”, “having”, “containing”, “involving”, and the like are to be understood to be open-ended, i.e., to mean including but not limited to.

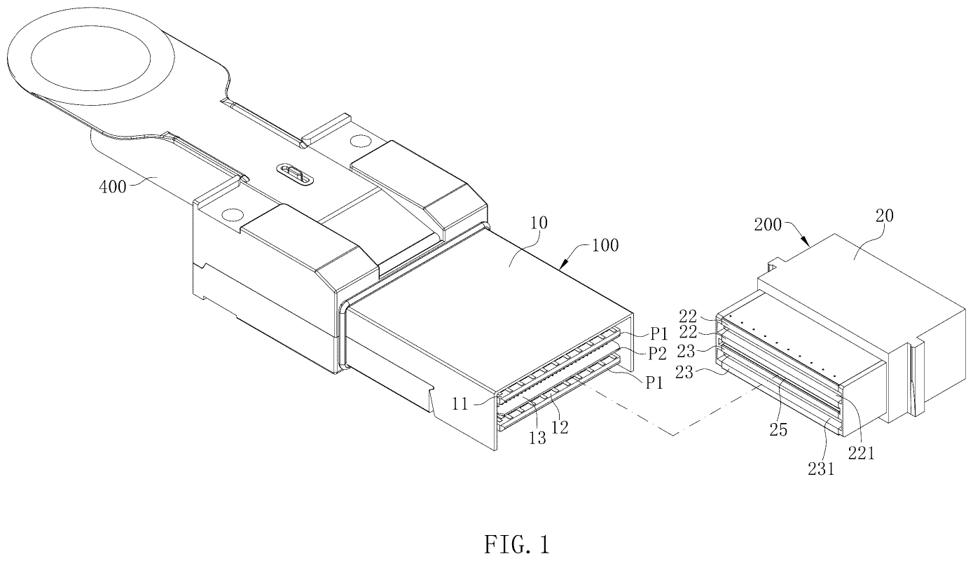

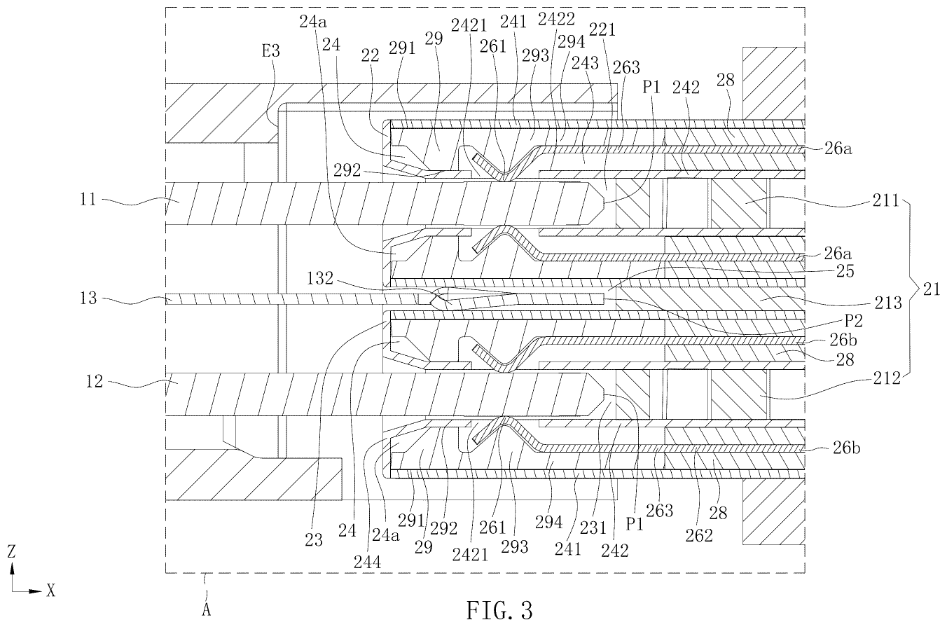

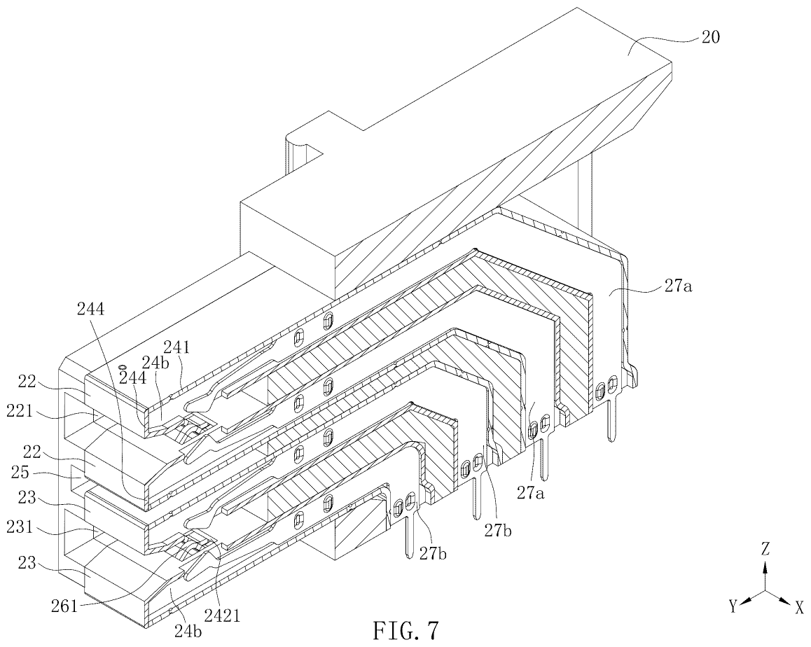

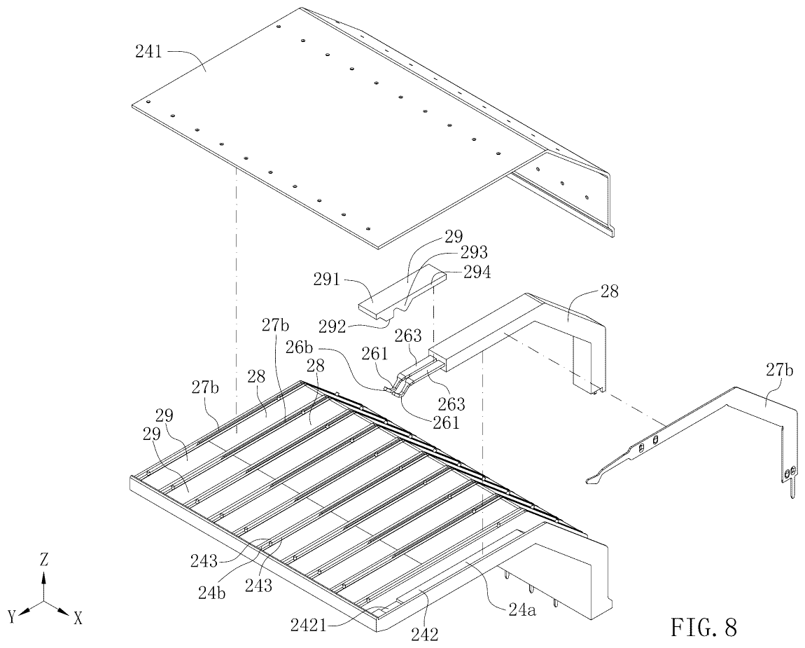

The description will be made as to the embodiments of the present invention in conjunction with the accompanying drawings in FIGS. 1-10. In accordance with the purposes of this invention, as embodied and broadly described herein, this invention, in one aspect, relates to a male connector, a female connector and an electrical connector assembly.

As shown in FIG. 1 to FIG. 8, certain embodiments of the present invention discloses an electrical connector assembly including a male connector 100 and a female connector 200, which is used to electrical contact a first mating component 400 to a second mating component 500. The male connector 100 is electrically contacted to the first mating component 400, and the first mating component 400 is preferably a cable wire. The female connector 200 is electrically contacted to the second mating component 500, and the second mating component 500 is preferably a circuit board.

As shown in FIG. 1 to FIG. 8, in the electrical connector assembly, a width direction of the female connector 200 is defined as a left-right direction (and the left-right direction is an extending direction of a Y-axis, where a positive direction of the Y-axis is right), an insertion direction of the male connector 100 being inserted into the female connector 200 is defined as a front-rear direction (and the front-rear direction is an extending direction of an X-axis), and a height direction of the female connector 200 is defined as a vertical direction (and the vertical direction is an extending direction of a Z-axis).

As shown in FIG. 1, the male connector 100 includes a conductive shell 10, a first substrate 11 and a second substrate 12 accommodated in the conductive shell 10, and a shielding sheet 13 accommodated in the conductive shell 10. The conductive shell 10 is made of a metal material. The shielding sheet 13 is located between the first substrate 11 and the second substrate 12 and is directed fixed on the conductive shell 10, thus facilitating grounding of the shielding shell 13. The first substrate 11 and the second substrate 12 are used to electrical contact the first mating component 400 to the second mating component 500.

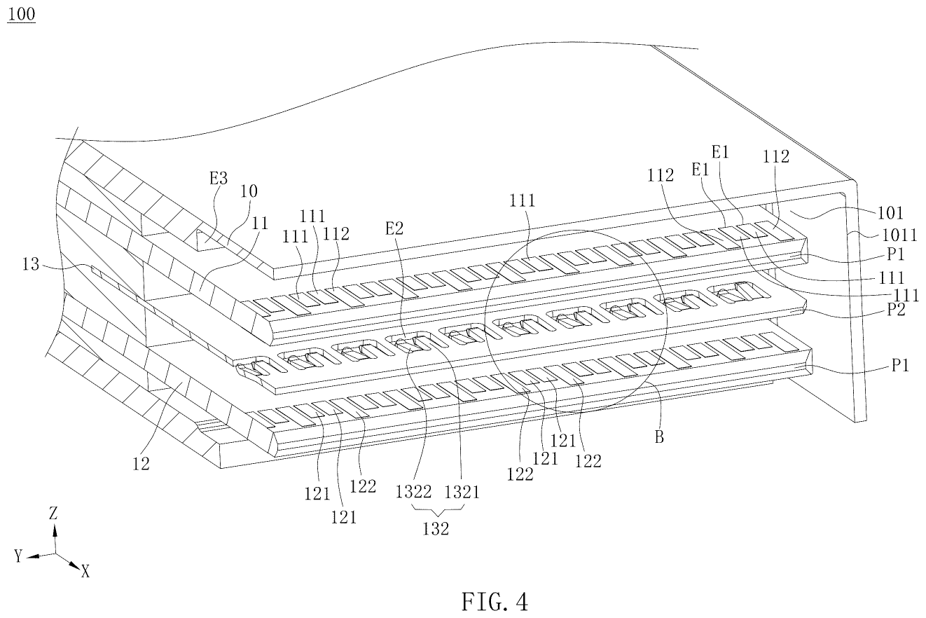

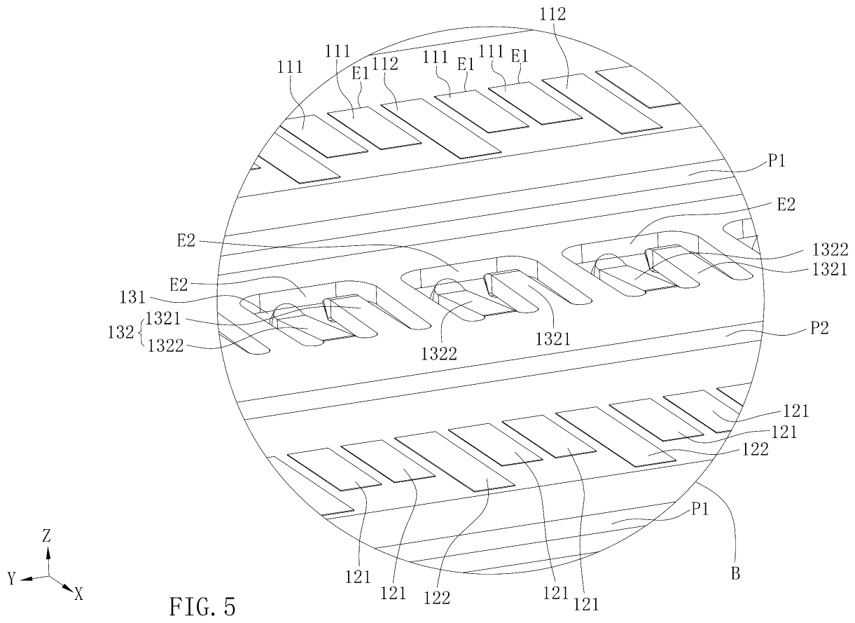

As shown in FIG. 4 to FIG. 5, the conductive shell 10 is concavely provided with a mating slot 101 forward from a rear thereof. The mating slot 101 is provided with a mating opening 1011 and a third inner edge E3. The first substrate 11 has a plurality of first signal pads 111 and a plurality of first grounding pads 112 arranged in a row, and the first signal pads 111 are used to transmit receiving signals. The second substrate 12 has a plurality of second signal pads 121 and a plurality of second grounding pads 122 arranged in a row, and the second signal pads 121 are used to transmit sending signals. Each of the first substrate 11 and the second substrate 12 has a first outer edge P1, and each of the first signal pads 111 and the second signal pads 121 has a first inner edge E1.

As shown in FIG. 4 to FIG. 5, the shielding sheet 13 is provided with a plurality of through slots 131, a plurality of sets of elastic sheets 132 and a second outer edge P2. Each set of elastic sheets 132 is located in each of the through slots 131. Viewing along the front-rear direction, the second outer edge P2 is located between the first inner edge E1 and the first outer edge P1. In other embodiments, viewing along the front-rear direction, the second outer edge P2 and the first outer edge P1 are flush. Each through slot 131 is provided with a second inner edge E2, and the second inner edge E2 is located between the first outer edge P1 and the third inner edge E3. Each set of elastic sheets 132 has a first elastic sheet 1321 and a second elastic sheet 1322. A free end of the first elastic sheet 1321 and a free end of the second elastic sheet 1322 both extend toward a side away from the mating opening 1011. Viewing along the vertical direction, the extending directions of the free end of the first elastic sheet 1321 and the free end of the second elastic sheet 1322 are opposite to each other.

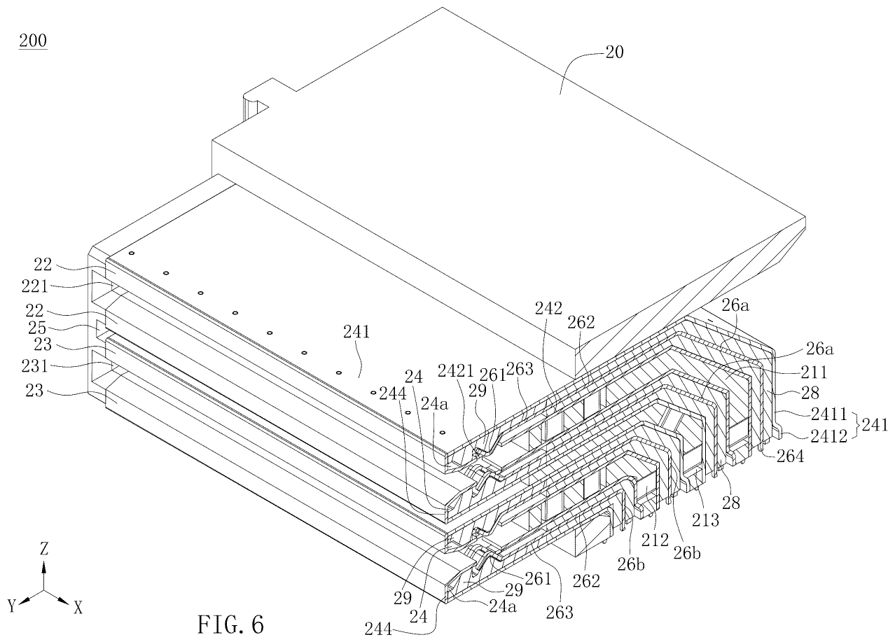

As shown in FIG. 6 to FIG. 8, The female connector 200 includes an insulating shell 20, a plurality of conductive plastics 21, a first conductive body 22, a second conductive body 23, an accommodating slot 25 located between the first conductive body 22 and the second conductive body 23, a plurality of first signal terminals 26a accommodated in the first conductive body 22, a plurality of second signal terminals 26b accommodated in the second conductive body 23, a plurality of insulating blocks 28 accommodated in the first conductive body 22 and the second conductive body 23, and a plurality of plastic blocks 29 accommodated in the first conductive body 22 and the second conductive body 23. The insulating shell 20 covers the first conductive body 22 and the second conductive body 23. The first conductive body 22 and the second conductive body 23 are both made of a metal material by powder metallurgy. In other embodiments, the first conductive body 22 and the second conductive body 23 may be formed by punching and bending a metal plate, or may be a conductive plastic material, or a conductive material formed by coating a metal layer on an insulating plastic material. The conductive plastics 21 have a first conductive plastic 211, a second conductive plastic 212 and a third conductive plastic 213. The insulating shell 20, the first conductive body 22, the second conductive body 23 and the third conductive plastic 213 altogether surround to form the accommodating slot 25. The first signal terminals 26a and the second signal terminals 26b electrically contact the second mating component 500 to the male connector 100.

As shown in FIG. 6 to FIG. 8, the first conductive body 22 is concavely provided with a first insertion slot 221 backward from a front thereof. The insulating shell 20, the first conductive body 22 and the first conductive plastic 211 altogether surround to form the first insertion slot 221. The first signal terminals 26a are exposed in the first insertion slot 221. The second conductive body 23 is concavely provided with a second insertion slot 231 backward from a front thereof. The insulating shell 20, the second conductive body 23 and the second conductive plastic 212 altogether surround to form the second insertion slot 231. The second signal terminals 26b are exposed in the second insertion slot 231.

As shown in FIG. 6 to FIG. 8, the first conductive body 22 and the second conductive body 23 are both provided with a plurality of receiving slots 24 arranged in two rows along the left-right direction. The receiving slots 24 have a plurality of first receiving slots 24a and a plurality of second receiving slots 24b. Each first receiving slot 24a of the first conductive body 22 accommodates two of the first signal terminals 26a, one of the insulating blocks 28 and one of the plastic blocks 29. Each second receiving slot 24b of the first conductive body 22 accommodates a first ground terminal 27a, and the first ground terminal 27a is in direct contact with the first conductive body 22 to facilitate grounding. Each first receiving slot 24a of the second conductive body 23 accommodates two of the second signal terminals 26b, one of the insulating blocks 28 and one of the plastic blocks 29. Each second receiving slot 24b of the second conductive body 23 accommodates a second ground terminal 27b, and the second ground terminal 27b is in direct contact with the second conductive body 23 to facilitate grounding. In other embodiments, each first receiving slot 24a of the first conductive body 22 accommodates one of the first signal terminals 26a, and each first receiving slot 24a of the second conductive body 23 accommodates one of the second signal terminals 26b.

As shown in FIG. 6 to FIG. 8, each receiving slot 24 is provided with a first conductive wall 241 and a second conductive wall 242 at two opposite sides, and two third conductive walls 243 and a fourth conductive wall 244 connecting the first conductive wall 241 and the second conductive wall 242. In the first conductive body 22, a portion of the first conductive wall 241 and a portion of the second conductive wall 242 are located at two opposite sides of a corresponding first signal terminal 26a along the vertical direction. In the second conductive body 23, a portion of the first conductive wall 241 and a portion of the second conductive wall 242 are located at two opposite sides of a corresponding second signal terminal 26b along the vertical direction. The second conductive wall 242 of the first conductive body 22 is provided with an opening 2421 at a location adjacent to the first insertion slot 221, and the receiving slots 24 of the first conductive body 22 are in communication with the first insertion slot 221 through the opening 2421. The second conductive wall 242 of the second conductive body 23 is also provided with an opening 2421 at a location adjacent to the second insertion slot 231, and the receiving slots 24 of the second conductive body 23 are in communication with the second insertion slot 231 through the opening 2421. Two adjacent receiving slots 24 are separated by one of the third conductive walls 243. The second conductive wall 242 has a wall surface 2422 located in the corresponding receiving slot 24. The fourth conductive wall 244 of the first conductive body 22 is located in front of the first signal terminals 26a, and the fourth conductive wall 244 of the second conductive body 23 is located in front of the second signal terminals 26b.

As shown in FIG. 6 to FIG. 8, the first signal terminals 26a and the second signal terminals 26b are provided horizontally, and the first ground terminal 27a and the second ground terminal 27b are provided vertically. The first signal terminals 26a are used to transmit the receiving signals, and the second signal terminals 26b are used to transmit the sending signals. Each of the first signal terminals 26a and the second signal terminals 26b has a contact portion 261, a fixing portion 262, an elastic portion 263 connecting the contact portion 261 and the fixing portion 262, and a conductive portion 264 connected to the fixing portion 262. Viewing along the vertical direction, the first elastic sheet 1321 and the second elastic sheet 1322 overlap with the projection of the contact portion 261. The fixing portion 262 and the insulating block 28 are formed by insert-molding. The fixing portion 262 and the elastic portion 263 are shielded by the second conductive wall 242. The fourth conductive wall 244 is located in front of the contact portion 261. The contact portion 261 of each first signal terminal 26a protrudes out of the first insertion slot 221 through the opening 2421, and the contact portion 261 of each second signal terminal 26b protrudes out of the second insertion slot 231 through the opening 2421. A connecting member 300 is electrically contacted to the conductive portion 264, and the connecting member 300 is located at a side of the conductive portion 264 adjacent to the first conductive wall 241. In the present embodiment, the connecting member 300 is a solder. In other embodiments, the connecting member 300 may be a solder ball, a solder body or a conductive component electrically contacted to the conductive portion 264. The first conductive wall 241 is provided with a plate portion 2411 located at one side of the fixing portion 262 and a protruding portion 2412 bending and extending from the plate portion 2411 toward a direction away from one end of the conductive portion 264, and a distance between the protruding portion 2412 and the conductive portion 264 is greater than a distance between the plate portion 2411 and the fixing portion 262.

As shown in FIG. 6 to FIG. 8, the plastic block 29 is located between the fourth conductive wall 244 and the insulating block 28 by assembly. Each plastic block 29 has a first abutting surface 291 and a second abutting surface 292 opposite to each other vertically, a first portion 293 located between the contact portion 261 and the first conductive wall 241, and a second portion 294 located between the elastic portion 263 and the first conductive wall 241. The first abutting surface 291 of the first conductive body 22 does not abut against the first conductive wall 241, and the second abutting surface 292 of the first conductive body 22 abuts against the second conductive wall 242. The first abutting surface 291 of the second conductive body 23 abuts against the first conductive wall 241, and the second abutting surface 292 of the second conductive body 23 does not abut against the second conductive wall 242. In other embodiments, the first abutting surface 291 and the second abutting surface 292 of the first conductive body 22 respectfully abut against the first conductive wall 241 and the second conductive wall 242, and the first abutting surface 291 and the second abutting surface 292 of the second conductive body 23 respectfully abut against the first conductive wall 241 and the second conductive wall 242. The first portion 293 and the contact portion 261 are provided at an interval. The first portion 293 protrudes toward the opening 2421 and does not pass beyond the wall surface 2422.

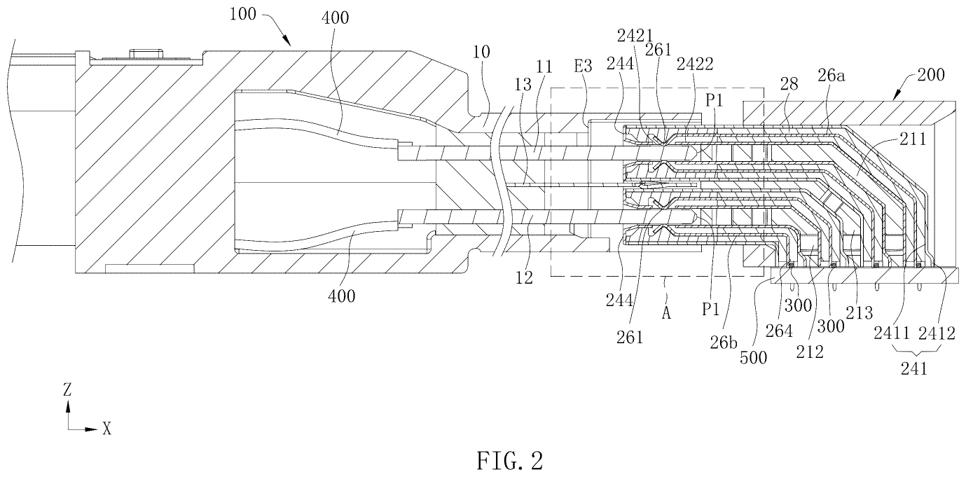

As shown in FIG. 2 to FIG. 3 and FIG. 6 to FIG. 8, when the male connector 100 and the female connector 200 mate with each other, the first insertion slot 221 is used to accommodate the first substrate 11, in which the first ground terminal 27a abuts against a corresponding first grounding pad 112 of the first substrate 11, the contact portion 261 of each first signal terminal 26a is in electrical contact with a corresponding first signal pad 111 of the first substrate 11, the contact portion 261 of each first signal terminal 26a and the first portion 293 are provided at an interval, and the elastic portion 263 of each first signal terminal 26a and the second portion 294 are in contact with each other. The second insertion slot 231 is used to accommodate the second substrate 12, in which the second ground terminal 27b abuts against a corresponding second grounding pad 122 of the second substrate 12, the contact portion 261 of each second signal terminal 26b is in electrical contact with a corresponding second signal pad 121 of the second substrate 12, the contact portion 261 of each second signal terminal 26b and the first portion 293 are provided at an interval, and the elastic portion 263 of each second signal terminal 26b and the second portion 294 are in contact with each other. The accommodating slot 25 is used to accommodate the shielding sheet 13. The first conductive body 22 and the second conductive body 23 are both accommodated in the mating slot 101, and are located at two opposite sides of the through slot 131 in the vertical direction. The first conductive body 22 and the second conductive body 23 are used to lap joint with the shielding sheet 13, in which the first elastic sheet 1321 is used to lap joint with the first conductive body 22, and the second elastic sheet 1322 is used to lap joint with the second conductive body 23. In other embodiments, the first conductive body 22 or the second conductive body 23 is used to lap joint with the shielding sheet 13, and the elastic sheet 132 is used to lap joint with the first conductive body 22 or the second conductive body 23. In other embodiments, the plastic block 29 and the insulating block 28 are integrally formed.

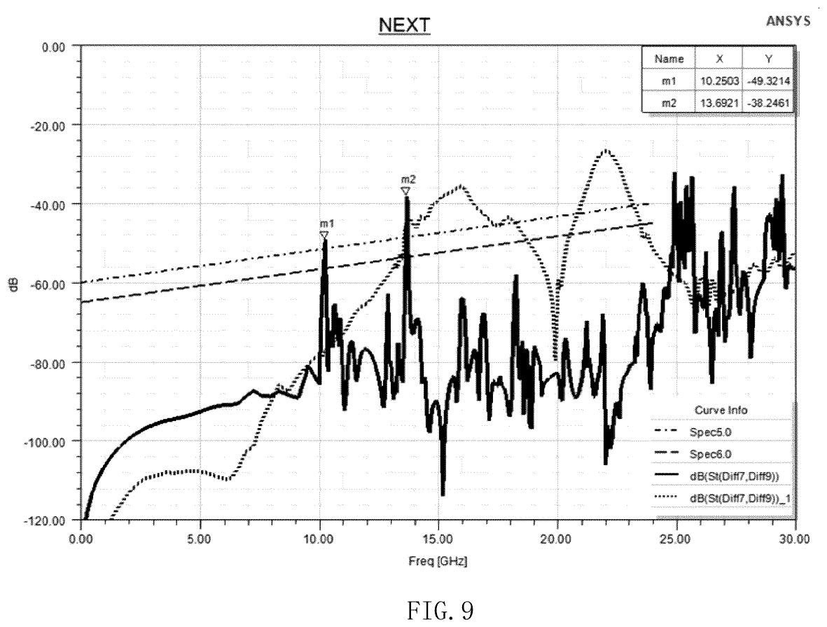

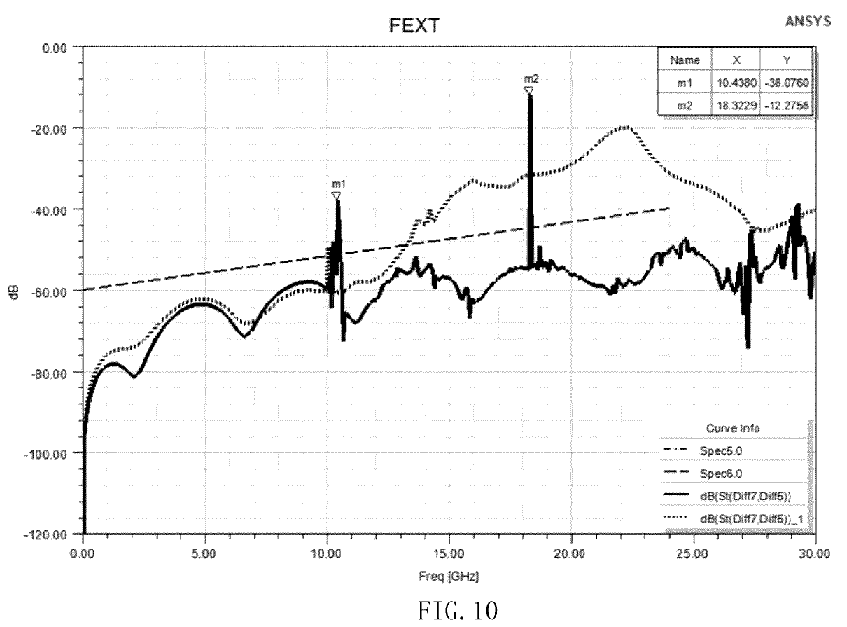

To better understand the technical effects achieved by the technical solutions of the present invention, referring to FIG. 9 and FIG. 10, respectively showing a simulation test chart showing comparison of the near-end crosstalk (NEXT) between a pair of signal terminals of the electrical connector assembly of the related art and a pair of signal terminals of the electrical connector assembly according to certain embodiments of the present invention and a simulation test chart showing comparison of the far-end crosstalk (FEXT) between a pair of signal terminals of the electrical connector assembly of the related art and a pair of signal terminals of the electrical connector assembly according to certain embodiments of the present invention. In FIG. 9, the horizontal coordinate shows the frequency, and the vertical coordinate shows the NEXT. In FIG. 10, the horizontal coordinate shows the frequency, and the vertical coordinate shows the FEXT. As shown in FIG. 9, in the electrical connector assembly of the related art, the frequency range of the NEXT of a pair of signal terminals (dB(St(Diff7, Diff9))_1) exceeding the Spec 5.0 specification line and the Spec 6.0 specification line is large, and in the electrical connector assembly according to certain embodiments of the present invention, the frequency range of the NEXT of a pair of signal terminals (dB(St(Diff7, Diff9))_1) exceeding the Spec5.0 specification line and the Spec6.0 specification line is small, where the NEXT value in most of the frequency range satisfies the Spec5.0 specification line and the Spec6.0 specification line, and the NEXT value in some of the frequency range is far superior to the Spec5.0 specification line and the Spec6.0 specification line. The technical solutions according to certain embodiments of the present invention are particularly significant in improving the NEXT. In the electrical connector assembly of the related art, the frequency range of the FEXT of a pair of signal terminals (dB(St(Diff7, Diff9))_1) exceeding the Spec 5.0 specification line and the Spec 6.0 specification line (where the Spec 5.0 specification line and the Spec 6.0 specification line coincide) is large, and in the electrical connector assembly according to certain embodiments of the present invention, the frequency range of the FEXT of a pair of signal terminals (dB(St(Diff7, Diff9))_1) exceeding the Spec 5.0 specification line and the Spec 6.0 specification line is small, where the FEXT value in most of the frequency range satisfies the Spec 5.0 specification line and the Spec 6.0 specification line. Thus, it can be seen that the technical solutions according to certain embodiments of the present invention may reduce the electromagnetic signal interference to the electrical connector assembly to a maximized degree.

In sum, the electrical connector assembly according to certain embodiments of the present invention has the following beneficial effects:
(1) The first substrate 11 of the male connector 100 is provided with a plurality of first signal pads 111 only used to transmit receiving signals, such that the NEXT in the first substrate 11 is minimized. The second substrate 12 of the male connector 100 is provided with a plurality of second signal pads 121 only used to transmit sending signals, such that the NEXT in the second substrate 12 is minimized. The first signal pads 111 of the first substrate 11 receive the electromagnetic signal interference sent from the second signal pads 121 of the second substrate 12, but the male connector 100 is provided with a shielding sheet 13 between the first substrate 11 and the second substrate 12, which may isolate most of the electromagnetic signal interference between the first substrate 11 and the second substrate 12.
(2) The female connector 200 is provided with a plurality of first signal terminals 26a arranged in a row and used only to transmit the receiving signals and a plurality of second signal terminals 26b arranged in a row and used only to transmit the sending signals, such that the NEXT among the first signal terminals 26a is minimized and the NEXT among the second signal terminals 26b is minimized. The first signal terminals 26a receive the signal interference sent from the second signal terminals 26b, but the female connector 200 is provided with a first conductive body 22 covering the first signal terminals 26a and a second conductive body 23 covering the second signal terminals 26b, and the first conductive body 22 and the second conductive body 23 may isolate most of the electromagnetic signal interference between the first signal terminals 26a and the second signal terminals 26b.
(3) When the male connector 100 is inserted into the female connector 200, under the condition that the shielding sheet 13 lap joints with the first conductive body 22 and/or the second conductive body 23, the shielding sheet 13 may shield the electromagnetic signal interference between the first signal terminals 26a and the second signal terminals 26b at a location of the opening 2421 of the female connector 200, and the first conductive body 22 and/or the second conductive body 23 may shield the electromagnetic signal interference between the first signal pads 111 and the second signal pads 121 at a location of the opening 2421 of the male connector 100. The shielding sheet 13 simultaneously lap joints with the first conductive body 22 and the second conductive body 23, thus facilitating the common grounding of the first conductive body 22 and the second conductive body 23 at the lap joint location, ensuring an equal electrical potential, which is conducive to enhancing the shielding effect, and further reducing the electromagnetic signal interference.
(4) The second outer edge P2 of the shielding sheet 13 is located between the first inner edge E1 and the first outer edge P1, or the second outer edge P2 and the first outer edge P1 are flush, thus ensuring the shielding sheet 13 not to protrude the first substrate 11, and thereby preventing the shielding sheet 13 from being first in contact with the female connector 200 and causing damages when the male connector 100 and the female connector 200 mate with each other, and ensuring the shielding sheet 13 to lap joint with the first conductive body 22 and the second conductive body 23 as early as possible. Further, the shielding sheet 13 may partially overlap with the first conductive body 22 and the second conductive body 23, thus effectively isolating the electromagnetic signal interference between the first conductive body 22 and the second conductive body 23.
(5) The shielding sheet 13 is provided with a plurality of sets of elastic sheets 132, and each set of elastic sheets 132 has a first elastic sheet 1321 and a second elastic sheet 1322, thus ensuring the balance of the strength of the shielding sheet 13 to lap joint with the first conductive body 22 and the second conductive body 23, reducing the elastic fatigue of the first elastic sheet 1321 and the second elastic sheet 1322, and further facilitating maintaining the stability of the lap joint. The free end of the first elastic sheet 1321 and the free end of the second elastic sheet 1322 both extend toward a side away from the mating opening 1011, thus preventing the shielding sheet 13 from first abutting against the free end of the first elastic sheet 1321 and the free end of the second elastic sheet 1322 when the shielding sheet 13 lap joints with the first conductive body 22 and the second conductive body 23 and thereby causing the first elastic sheet 1321 and the second elastic sheet 1322 to easily break, and further ensuring the smoothness and stability of the shielding sheet 13 to lap joint with the first conductive body 22 and the second conductive body 23. Viewing along the vertical direction, the extending directions of the free end of the first elastic sheet 1321 and the free end of the second elastic sheet 1322 are opposite to each other, thus allowing the shielding sheet 13 to simultaneously lap joint with the first conductive body 22 and the second conductive body 23 at different locations along the vertical direction.
(6) When the male connector 100 and the female connector 200 mate with each other, the first conductive body 22 and the second conductive body 23 of the female connector 200 are both accommodated in the mating slot 101 of the male connector 100, and are respectively located at an upper side and a lower side of the through slots 131. The second inner edge E2 of each through slot 131 is located between the first outer edge P1 and the third inner edge E3 of the mating slot 101, thus ensuring the first conductive body 22 and the second conductive body 23 to shield the through slots 131 in the vertical direction, preventing the electromagnetic signals from leaking out of the through slots 131, and ensuring effectively isolating the electromagnetic signal interference of the first conductive body 22 and the second conductive body 23.
(7) Each receiving slot 24 accommodates at least one of the first signal terminals 26a. Two adjacent receiving slots 24 are separated by one of the third conductive walls 243. Each third conductive wall 243 may shield the electromagnetic signal interference between the first signal terminals 26a in the two adjacent receiving slots 24. The fixing portion 262 and the elastic portion 263 are shielded by the second conductive wall 242. Only the contact portion 261 protrudes out of the first insertion slot 221 through the opening 2421, which is conducive to shielding the electromagnetic signal interference to more portions of the first signal terminals 26a in the direction of the second conductive wall 242, and further enhancing the high frequency characteristics of the female connector 200.
(8) A portion of the first conductive wall 241 and a portion of the second conductive wall 242 are located at two opposite sides of a corresponding first signal terminal 26a along the vertical direction, which is used to shield the electromagnetic signal interference of the first signal terminal 26a in the vertical direction. The fourth conductive wall 244 is located in front of the corresponding first signal terminal 26a, which is used to shield the electromagnetic signal interference in front of the first signal terminal 26a.
(9) The plastic block 29 and the first signal terminal 26a are accommodated in a same receiving slot 24, and the first portion 293 of the plastic block 29 is located between the contact portion 261 of the first signal terminal 26a and the first conductive wall 241. The first portion 293 and the contact portion 261 are provided at an interval. Air exists between the first portion 293 and the contact portion 261. Since the dielectric constant of the air is low, according to the formula

$$C = \frac{ε S}{d}$$

(where C is the capacitance, and ε is a dielectric constant of the transmission medium), the capacitance of the contact portion 261 may be adjusted to be reduced. It can be seen from the formula

$${Z}_{characteristic impedance} = \sqrt{\frac{L}{C}}$$

that the characteristic impedance of the contact portion 261 may be adjusted to be increased. The first portion 293 protrudes toward the opening 2421 and does not pass beyond the wall surface 2422, thus preventing the first signal terminal 26a from moving toward the first portion 293 and thereby being in contact with the first portion 293 after abutting against the first substrate 11 of the male connector 100, and thereby affecting the high frequency adjusting effect of the plastic block 29.
(10) The fixing portion 262 is covered by the insulating block 28, thus preventing the fixing portion 262 from being in contact with the first conductive body 22 and short-circuiting. When the signals are transmitted in the first signal terminals 26a, the contact portion 261 and the elastic portion 263 protrude out of the insulating block 28 and are exposed in the air. Since the dielectric constant of the air is low, according to the formula

$$C = \frac{ε S}{d}$$

(where U is the capacitance, and ε is a dielectric constant of the transmission medium), when the contact portion 261 and the elastic portion 263 are exposed in the air, the capacitance at the contact portion 261 and the elastic portion 263 will be lower than the capacitance at the fixing portion 262. It can be seen from the formula

$${Z}_{characteristic impedance} = \sqrt{\frac{L}{C}}$$

that the characteristic impedance at the contact portion 261 and the elastic portion 263 will be higher than the characteristic impedance at the fixing portion 262. The dielectric constant of the plastic block 29 is greater than the dielectric constant of the air, and by providing the plastic block 29 at one side of the contact portion 261 and the elastic portion 263, the capacitance of the contact portion 261 and the elastic portion 263 may be increased, thereby reducing the characteristic impedance thereof, such that the characteristic impedance thereof and the characteristic impedance of the fixing portion 262 are continuous, preventing from indirect reflection of electromagnetic wave signals in the case of impedance mismatch, and enhancing the high frequency characteristics.
(11) The first conductive wall 241 and/or the second conductive wall 242 support the plastic block 29, such that the location of the plastic block 29 relative to the first signal terminal 26a is relatively stable, thereby ensuring the high frequency characteristics of the first signal terminal 26a adjusted by the plastic block 29 to be more stable.
(12) When the male connector 100 and the female connector 200 mate with each other, the first substrate 11 abuts against the contact portion 261. When the signals are transmitted in the first signal terminals 26a, the capacitance of the contact portion 261 will be higher than the capacitance of the elastic portion 263. It can be seen from the formula

$${Z}_{characteristic impedance} = \sqrt{\frac{L}{C}}$$

that, in each first signal terminal 26a, the characteristic impedance at the contact portion 261 will be lower than the characteristic impedance at the elastic portion 263. Since the dielectric constant of the air is low, according to the formula

$$C = \frac{ε S}{d}$$

(where C is the capacitance, and ε is a dielectric constant of the transmission medium), by designing the contact portion 261 and the first portion 293 of the plastic block 29 to be provided at an interval, air exists between the contact portion 261 and the first portion 293, and by designing the elastic portion 263 and the second portion 294 to be in contact with each other, there is no air between the elastic portion 263 and the second portion 294. The dielectric constant of the second portion 294 of the plastic block 29 is greater than that of the air, thus ensuring the capacitance of the elastic portion 263 to be increased to be greater than the capacitance of the contact portion 261, and the characteristic impedance of the elastic portion 263 is reduced more than the characteristic impedance of the contact portion 261, such that the characteristic impedance of the elastic portion 263 and the characteristic impedance of the contact portion 261 are continuous, preventing from indirect reflection of electromagnetic wave signals in the case of impedance mismatch, and enhancing the high frequency characteristics.
(13) The first elastic sheet 1321 and the second elastic sheet 1322 overlap with a projection of the contact portion 261, which is conducive to the first elastic sheet 1321 pressing the first conductive body 22 to move upward when the first elastic sheet 1321 is used to upward lap joint with the first conductive body 22, and further conducive to the contact portion 261 of each first signal terminal 26a upward abutting against the first substrate 11. Meanwhile, it is conducive to the second elastic sheet 1322 pressing the second conductive body 23 to move downward when the second elastic sheet 1322 is used to downward lap joint with the second conductive body 23, and further conducive to the contact portion 261 of each second signal terminal 26b downward abutting against the second substrate 12.
(14) When the signals are transmitted in the first signal terminals 26a, according to the formula

$$C = \frac{ε S}{d}$$

(where C is the capacitance, ε is a dielectric constant of the transmission medium, and d is a distance between the two conductors), a connecting member 300 is electrically contacted to the conductive portion 264, and the connecting member 300 is located at one side of the conductive portion 264 adjacent to the first conductive wall 241. Viewing the connecting member 300 and the conductive portion 264 as a whole, if the first conductive wall 241 is not provided with the protruding portion 2412, and the plate portion 2411 extends to one side of the connecting member 300, a distance between the plate portion 2411 and the fixing portion 262 is greater than a distance between the plate portion 2411 and the connecting member 300, and the capacitance of the fixing portion 262 will be lower than the capacitance of the conductive portion 264. It can be seen from the formula

$${Z}_{characteristic impedance} = \sqrt{\frac{L}{C}}$$

that, in each first signal terminal 26a, the characteristic impedance of the fixing portion 262 will be higher than the characteristic impedance of the conductive portion 264. By providing a protruding portion 2412 bending and extending from the plate portion 2411 toward a direction away from one end of the conductive portion 264 in the first conductive wall 241, a distance between the protruding portion 2412 and the conductive portion 264 is greater than a distance between the plate portion 2411 and the fixing portion 262, thus reducing the capacitance of the conductive portion 264, thereby increasing the characteristic impedance of the conductive portion 264, such that the characteristic impedance of the conductive portion 264 and the characteristic impedance of the fixing portion 262 are continuous, preventing from indirect reflection of electromagnetic wave signals in the case of impedance mismatch, and enhancing the high frequency characteristics.

The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments were chosen and described in order to explain the principles of the invention and their practical application so as to activate others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. A male connector, comprising:
a conductive shell;
a first substrate, accommodated in the conductive shell, wherein the first substrate has a plurality of first signal pads arranged in a row, and the first signal pads are configured to transmit receiving signals;
a second substrate, accommodated in the conductive shell, wherein the second substrate has a plurality of second signal pads arranged in a row, and the second signal pads are configured to transmit sending signals; and
a shielding sheet, accommodated in the conductive shell and located between the first substrate and the second substrate.

2. The male connector according to claim 1, wherein the first substrate has a first outer edge, each of the first signal pads has a first inner edge, the shielding sheet has a second outer edge, and viewing a front-rear direction, the second outer edge is located between the first inner edge and the first outer edge, or the second outer edge and the first outer edge are flush.

3. The male connector according to claim 1, wherein the conductive shell is concavely provided with a mating slot along a front-rear direction, the mating slot is provided with a mating opening, the shielding sheet is provided with a plurality of sets of elastic sheets, each of the sets of elastic sheets has a first elastic sheet and a second elastic sheet, a free end of the first elastic sheet and a free end of the second elastic sheet both extend toward a side away from the mating opening, and viewing along a vertical direction, an extending direction of the free end of the first elastic sheet and an extending direction of the free end of the second elastic sheet are opposite to each other.

4. The male connector according to claim 1, wherein the conductive shell is concavely provided with a mating slot along a front-rear direction, the shielding sheet is provided with a plurality of through slots and at least one elastic sheet located in the through slots, each of the through slots is provided with a second inner edge, the mating slot is provided with a third inner edge, each of the first substrate and the second substrate has a first outer edge, and the second inner edge is located between the first outer edge and the third inner edge.

5. A second connector, comprising:
a first conductive body, provided with a first insertion slot;
a second conductive body, provided with a second insertion slot;
an accommodating slot, located between the first conductive body and the second conductive body and configured to accommodate a shielding sheet of a male connector, wherein the first conductive body and the second conductive body are configured to be contacted to the shielding sheet;
a plurality of first signal terminals, accommodated in the first conductive body and protruding out of the first insertion slot, wherein the first signal terminals are configured to transmit receiving signals; and
a plurality of second signal terminals, accommodated in the second conductive body and protruding out of the second insertion slot, wherein the second signal terminals are configured to transmit sending signals.

6. The female connector according to claim 5, wherein the first conductive body is provided with a plurality of receiving slots at least arranged in a row along a left-right direction, each of the receiving slots is provided with a first conductive wall and a second conductive wall at two opposite sides and two third conductive walls connecting the first conductive wall and the second conductive wall, a portion of the first conductive wall and a portion of the second conductive wall are located at two opposite sides of a corresponding one of the first signal terminals along a vertical direction, the second conductive wall is provided with an opening at a location adjacent to the first insertion slot, each of the receiving slots is in communication with the first insertion slot through the opening, two adjacent ones of the receiving slots are separated by one of the third conductive walls, each of the receiving slots accommodates at least one of the first signal terminals, each of the first signal terminals has a contact portion, a fixing portion and an elastic portion connecting the contact portion and the fixing portion, the fixing portion and the elastic portion of the corresponding one of the first signal terminals are shielded by the second conductive wall, and the contact portion protrudes out of the first insertion slot through the opening.

7. The female connector according to claim 5, wherein the first conductive body is provided with a plurality of receiving slots at least arranged in a row along a left-right direction, each of the receiving slots accommodates at least one of the first signal terminals, each of the receiving slots is provided with a first conductive wall, a second conductive wall and a fourth conductive wall connecting the first conductive wall and the second conductive wall, a portion of the first conductive wall and a portion of the second conductive wall are located at two opposite sides of a corresponding one of the first signal terminals along a vertical direction, and the fourth conductive wall is located in front of the corresponding one of the first signal terminals.

8. The female connector according to claim 5, wherein the first conductive body is provided with a plurality of receiving slots at least arranged in a row along a left-right direction, each of the receiving slots accommodates a plastic block and at least one of the first signal terminals, each of the receiving slots is provided with a first conductive wall and a second conductive wall at two opposite sides, a portion of the first conductive wall and a portion of the second conductive wall are located at two opposite sides of a corresponding one of the first signal terminals along a vertical direction, the second conductive wall is provided with an opening at a location adjacent to the first insertion slot, each of the receiving slots is in communication with the first insertion slot through the opening, each of the first signal terminals has a contact portion protruding out of the first insertion slot through the opening, the plastic block has a first portion located between the contact portion and the first conductive wall, the first portion and the contact portion are provided at an interval, the second conductive wall has a wall surface located in a corresponding one of the receiving slots, and the first portion protrudes toward the opening and does not pass beyond the wall surface.

9. The female connector according to claim 5, wherein the first conductive body is provided with a plurality of receiving slots at least arranged in a row along a left-right direction, each of the receiving slots accommodates an insulating block, a plastic block and at least one of the first signal terminals, each of the first signal terminals has a contact portion, an elastic portion connected to the contact portion and a fixing portion connected to the elastic portion arranged forward from a front thereof, the fixing portion and the insulating block are formed by insert-molding, each of the receiving slots is provided with a fourth conductive wall located in front of the contact portion, and the plastic block is located between the fourth conductive wall and the insulating block.

10. The female connector according to claim 9, wherein each of the receiving slots is provided with a first conductive wall and a second conductive wall, a portion of the first conductive wall and a portion of the second conductive wall are located at two opposite sides of a corresponding one of the first signal terminals along a vertical direction, the plastic block has a first abutting surface and a second abutting surface opposite to each other vertically, the first abutting surface abuts against the first conductive wall, and/or the second abutting surface abuts against the second conductive wall.

11. The female connector according to claim 5, wherein the first conductive body is provided with a plurality of receiving slots at least arranged in a row along a left-right direction, each of the receiving slots is provided with a first conductive wall located at one side of a corresponding one of the first signal terminals, each of the first signal terminals has a fixing portion and a conductive portion connected to the fixing portion, a connecting member is electrically contacted to the conductive portion, the connecting member is located at one side of the conductive portion adjacent to the first conductive wall, the first conductive wall is provided with a plate portion located at one side of the fixing portion and a protruding portion bending and extending from the plate portion toward a direction away from one end of the conductive portion, and a distance between the protruding portion and the conductive portion is greater than a distance between the plate portion and the fixing portion.

12. The female connector according to claim 5, further comprising: an insulating shell, covering the first conductive body and the second conductive body, wherein the insulating shell, the first conductive body and a first conductive plastic altogether surround to form the first insertion slot, the insulating shell, the second conductive body and a second conductive plastic altogether surround to form the second insertion slot, the insulating shell, the first conductive body, the second conductive body and a third conductive plastic altogether surround to form the accommodating slot, each of the first conductive body and the second conductive body is provided with a plurality of receiving slots arranged in two rows along a left-right direction, the receiving slots have a plurality of first receiving slots and a plurality of second receiving slots, each of the first receiving slots of the first conductive body accommodates at least one of the first signal terminals, each of the second receiving slots of the first conductive body accommodates a first ground terminal, the first ground terminal and the first conductive body are in direct contact, each of the first receiving slots of the second conductive body accommodates at least one of the second signal terminals, each of the second receiving slots of the second conductive body accommodates a second ground terminal, the second ground terminal and the second conductive body are in direct contact, the first signal terminals and the second signal terminals are provided horizontally, and the first ground terminal and the second ground terminal are provided vertically.

13. An electrical connector assembly, comprising:
a male connector, provided with a conductive shell;
a first substrate, accommodated in the conductive shell, wherein the first substrate is configured to transmit receiving signals;
a second substrate, accommodated in the conductive shell, wherein the second substrate is configured to transmit sending signals;
at least one shielding sheet, accommodated in the conductive shell and located between the first substrate and the second substrate;
a female connector, provided with a first conductive body, a second conductive body and an accommodating slot located between the first conductive body and the second conductive body, wherein the first conductive body is provided with a first insertion slot, and the second conductive body is provided with a second insertion slot;
a plurality of first signal terminals, accommodated in the first conductive body and protruding out of the first insertion slot, wherein the first signal terminals are configured to transmit the receiving signals; and
a plurality of second signal terminals, accommodated in the second conductive body and protruding out of the second insertion slot, wherein the second signal terminals are configured to transmit the sending signals;
wherein when the male connector and the female connector mate with each other, the first insertion slot is configured to accommodate the first substrate, the first signal terminals and the first substrate are electrically contacted to each other, the second insertion slot is configured to accommodate the second substrate, the second signal terminals and the second substrate are electrically contacted to each other, the accommodating slot is configured to accommodate the shielding sheet, and the first conductive body and/or the second conductive body are configured to lap joint with the shielding sheet.

14. The electrical connector assembly according to claim 13, wherein the conductive shell is concavely provided with a mating slot along a front-rear direction, the mating slot is provided with a mating opening, the shielding sheet is provided with a plurality of sets of elastic sheets, each of the sets of elastic sheets has a first elastic sheet and a second elastic sheet, the first elastic sheet is configured to lap joint with the first conductive body, the second elastic sheet is configured to lap joint with the second conductive body, a free end of the first elastic sheet and a free end of the second elastic sheet both extend toward a side away from the mating opening, and viewing along a vertical direction, an extending direction of the free end of the first elastic sheet and an extending direction of the free end of the second elastic sheet are opposite to each other.

15. The electrical connector assembly according to claim 13, wherein the conductive shell is concavely provided with a mating slot along a front-rear direction, the shielding sheet is provided with a plurality of through slots and at least one elastic sheet located in the through slots, the elastic sheet is configured to lap joint with the first conductive body and/or the second conductive body, each of the through slots is provided with a second inner edge, the mating slot is provided with a third inner edge, each of the first substrate and the second substrate has a first outer edge, the second inner edge is located between the first outer edge and the third inner edge, and when the male connector and the female connector mate with each other, the first conductive body and the second conductive body are accommodated in the mating slot and are respectively located at two opposite sides of the through slot in a vertical direction.

16. The electrical connector assembly according to claim 13, wherein the first conductive body is provided with a plurality of receiving slots at least arranged in a row along a left-right direction, each of the receiving slots accommodates a plastic block and at least one of the first signal terminals, each of the receiving slots is provided with a first conductive wall and a second conductive wall at two opposite sides, a portion of the first conductive wall and a portion of the second conductive wall are located at two opposite sides of a corresponding one of the first signal terminals along a vertical direction, the second conductive wall is provided with an opening at a location adjacent to the first insertion slot, each of the receiving slots is in communication with the first insertion slot through the opening, each of the first signal terminals has a contact portion protruding out of the first insertion slot through the opening and an elastic portion connected to the contact portion, the plastic block has a first portion located between the contact portion and the first conductive wall and a second portion located between the elastic portion and the first conductive wall, and when the male connector and the female connector mate with each other, the first substrate and the contact portion abut against each other, the contact portion and the first portion are provided at an interval, and the elastic portion and the second portion are in contact with each other.

17. The electrical connector assembly according to claim 13, wherein the shielding sheet is provided with a plurality of sets of elastic sheets, each of the sets of elastic sheets has a first elastic sheet and a second elastic sheet, the first elastic sheet is configured to upward lap joint with the first conductive body, the second elastic sheet is configured to downward lap joint with the second conductive body, each of the first signal terminals has a contact portion in electrical contact with the first substrate, each of the second signal terminals has a contact portion in electrical contact with the second substrate, and viewing along a vertical direction, the first elastic sheet and the second elastic sheet overlap with a projection of the contact portion.
